(19) United States
(12) Patent Application Publication
(10) Pub. No.: US 2020/0337221 A1
(43) Pub. Date: Oct. 29, 2020

(54) HOE OPENER ASSEMBLY

(71) Applicant: CNH Industrial Canada, Ltd., Saskatoon (CA)

(72) Inventors: Martin J. Roberge, Saskatoon (CA); Joel Gervais, Saskatoon (CA); Robin Schilling, Darfield (CA); Guillaume C. Boily, Martensville (CA)

(21) Appl. No.: 16/395,132

(22) Filed: Apr. 25, 2019

(51) Int. Cl. A01C 7/06; A01C 5/06; A01C 7/20

(52) U.S. Cl. CPC A01C 7/06; A01C 7/206; A01C 5/062

(57) ABSTRACT

A row unit of an agricultural seeding implement has a hoe opener assembly that may engage soil to form a trench in the soil and to deposit one or more agricultural products in the trench. The hoe opener assembly has a base structure having a mount and a nose removeably coupled to the base structure. The nose may form the trench in the soil. The hoe opener assembly also has a double shoot attachment removeably coupled to the mount. The double shoot attachment may separately deposit the fertilizer and the seeds into the trench. The hoe opener assembly also has a first conduit that may deliver the fertilizer to the double shoot attachment and a second conduit that may deliver the seeds to the double shoot attachment.

### BACKGROUND

The present disclosure relates to agricultural equipment, and more particularly to a configurable hoe opener having interchangeable components for single shoot or double shoot deposition of fertilizer and seed.

Seeding implements are typically towed behind a tractor or other work vehicle across a field. For example, a tongue of the seeding implement may be connected to a drawbar of the tractor, or a mast of the seeding implement may be connected to a hitch of the tractor. In order to plant seeds within the field, the seeding implement typically includes ground engaging tools or hoe openers that form trenches in the soil for seed and fertilizer deposition into the soil of the field. Different types of hoe openers may be utilized with different techniques of delivering the seed and fertilizer into the soil. For example, a single shoot hoe opener deposits seed, fertilizer, or a mixture of seed and fertilizer in the trench after it is formed by a nose of the hoe opener. In contrast, a double shoot hoe opener separately deposits the seed and the fertilizer in the trench after it is formed by the nose of the hoe opener. In order to switch between using a single shoot hoe opener and a double shoot hoe opener, an operator of the seeding implement may decouple the single shoot opener from the seeding implement and couple the double shoot opener, or vice versa. However, this process may be time-consuming and laborious. Additionally, repeated contact between the soil and the hoe opener may cause wear on the hoe opener over time and, ultimately, the hoe opener may be repaired or replaced. However, repair or replacement of the entire hoe opener may be costly.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a row unit of an agricultural seeding implement has a hoe opener assembly that may engage soil to form a trench in the soil and to deposit one or more agricultural products in the trench. The hoe opener assembly has a base structure having a mount and a nose removeably coupled to the base structure. The nose may form the trench in the soil. The hoe opener assembly also has a double shoot attachment removeably coupled to the mount. The double shoot attachment may separately deposit the fertilizer and the seeds into the trench. The hoe opener assembly also has a first conduit that may deliver the fertilizer to the double shoot attachment and a second conduit that may deliver the seeds to the double shoot attachment.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units with respective hoe opener assemblies;

FIG. 2 is a side view of an embodiment of a row unit of the agricultural implement of FIG. 1 having a hoe opener assembly configured for double shoot operation;

FIG. 3 is a side view of the hoe opener assembly of FIG. 2 configured for double shoot operation;

FIG. 4 is a back, perspective view of the hoe opener assembly of FIG. 3 configured for double shoot operation;

FIG. 5 is an exploded view of a base structure of the hoe opener assembly of FIG. 2 and a double shoot attachment; and

FIG. 6 is an exploded view of the base structure of the hoe opener assembly of FIG. 2 and an embodiment of a single shoot attachment.

### DETAILED DESCRIPTION

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Modern farming uses a variety of agricultural implements to harvest crops, prepare the soil for planting, and for planting. These agricultural implements are commonly referred to as harvesters, tillers, seeders, and planters. A seeder first opens a trench in the soil with an opening system. The seeder then deposits seeds and/or fertilizer into the trench, after which the trench may be covered with soil by a closing system. In order to plant seeds, the seeder may use a hoe opener that forms the trench in the soil with a nose and delivers the seeds and/or the fertilizer to the trench before the trench is covered with soil. An operator may use different types of hoe openers to implement different techniques for delivering the seed and/or fertilizer into the soil. For example, a single shoot hoe opener deposits seed, fertilizer, or a mixture of seed and fertilizer in the trench, while a double shoot hoe opener separately deposits seeds and fertilizer in the trench. In order for an operator to switch between using a single shoot hoe opener and a double shoot hoe opener, the operator decouples the type of hoe opener in use and couples the desired hoe opener. However, this process may be time-consuming and laborious. Additionally, repeated contact between the soil and the hoe opener may cause wear on the hoe opener over time and, ultimately, the hoe opener may be repaired or replaced. As such, it may be desirable to provide an improved hoe opener that decreases the time and labor associated with switching between a single shoot configuration and a double shoot configuration, as well as reduces costs compared to the repair or the replacement of the hoe opener.

Accordingly, embodiments of the present disclosure are directed to an improved hoe opener assembly that may decrease the time and labor associated with switching between a single shoot configuration and a double shoot configuration, as well as reducing repair and replacement costs. For example, the hoe opener assembly may have a base structure that may be utilized with both the single shoot configuration and the double shoot configuration of the hoe opener assembly. In the single shoot configuration, a rear mount of the base structure may be coupled to a single shoot attachment that facilitates delivery of seeds, fertilizer, or a mixture of seeds and fertilizer to a trench created by a nose of the hoe opener. In the double shoot configuration, the rear mount of the base structure may be coupled to a double shoot attachment that facilitates separate delivery of the seeds and the fertilizer to the trench. In this way, an operator may easily and efficiently exchange the single shoot attachment with the double shoot attachment, or vice versa, based on the desired seed and fertilizer deposition technique.

Additionally, certain components of the hoe opener assembly may be replaceable to reduce costs compared to the repair or the replacement of the hoe opener assembly after experiencing wear. For example, the nose of the hoe opener assembly may directly engage the soil, and the single shoot attachment and the double shoot attachment may also engage the soil during operation of the hoe opener assembly. As such, embodiments of the present disclosure provide a replaceable nose of the hoe opener assembly in addition to the interchangeable single shoot and double shoot attachments described above. That is, the nose of the hoe opener, the single shoot attachment, and the double shoot attachment are removeably coupled to the base structure of the hoe opener assembly, such that the components may easily and efficiently be replaced with replacement components by an operator after the components have experienced a certain amount of wear.

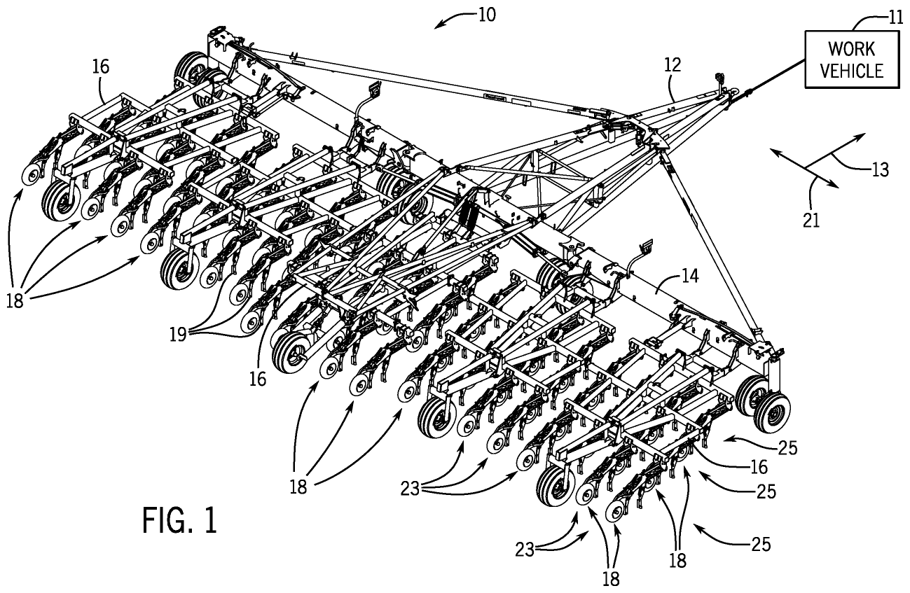

With the foregoing in mind, FIG. 1 is a perspective view of an embodiment of an agricultural implement 10 (e.g., seeding implement). The implement 10 is designed to be towed behind a work vehicle 11, such as a tractor. The implement 10 includes a tow bar assembly 12, which is shown in the form of an A-frame hitch assembly. The tow bar assembly 12 may include a hitch used to attach to an appropriate tractor hitch via a ball, clevis, or other coupling. The tow bar assembly 12 is coupled to a tool bar 14 which supports multiple tool frames 16. Each tool frame 16 includes multiple seeding implements, such as the illustrated row units 18 having respective hoe opener assemblies 19. In some embodiments, each row unit 18 includes a depth adjustment assembly configured to facilitate rapid reconfiguration of the hoe opener assembly 19 for varying penetration depths. The work vehicle 11 may pull the seeding implement 10 in a direction of travel 13. Multiple row units 18 of the seeding implement 10 are arranged along an axis 21 that is substantially perpendicular to the direction of travel 13.

Each hoe opener assembly 19 of the row units 18 may be configured to engage the field and form a trench such that one or more agricultural products (e.g., seed, fertilizer, or inoculant) may be directed into the trench. In some embodiments, the row units 18 of the seeding implement 10 are arranged in rows 23 across the axis 21, where each row 23 may be generally parallel to the direction of travel 13. In addition, the row units 18 may be arranged in one or more ranks 25, where the ranks 25 of the row units 18 are offset from each other along the direction of travel 13. For example, the seeding implement 10 shown in FIG. 1 has twenty-two (22) rows 23, and each row has three (3) ranks of row units 18. Embodiments of the seeding implement 10 may have multiple rows 23 of hoe opener assemblies 18, such as between 2 to 50 rows, 3 to 40 rows, 4 to 30 rows, or 5 to 25 rows. Moreover, embodiments of the seeding implement 10 may have one or more ranks 25, such as 1, 2, 3, 4, 5, 6, or more ranks 25.

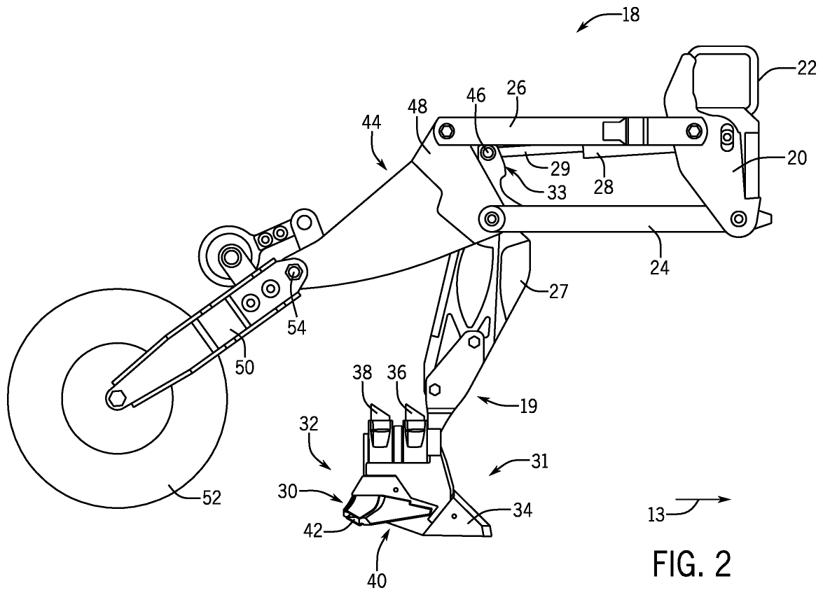

FIG. 2 is a side view of an embodiment of a row unit 18 of the seeding implement having a hoe opener assembly 19 configured for double shoot operation. In the illustrated embodiment, the hoe opener assembly 19 has a replaceable nose 34 at a front side 31 of the hoe opener assembly 19 and a double shoot attachment 30 at a rear side 32 of the hoe opener assembly 19. As described above, the work vehicle 11 may pull the seeding implement 10 in the direction of travel 13 through a field. As the row unit 18 moves in the direction of travel 13, the hoe opener assembly 19 may engage the soil with the nose 34 (e.g., a knife or a blade) of the hoe opener assembly 19 and form a trench in the field. The hoe opener assembly 19 may then deposit one or more agricultural products (e.g., seed, fertilizer, inoculant) into the trench via a front conduit 36 (e.g., a front inlet hose) and/or a rear conduit 38 (e.g., a rear inlet hose), which are positioned behind the nose 34 of the hoe opener assembly 19. For example, during double shoot operation of the hoe opener assembly 19, the front conduit 36 may deliver fertilizer to a central section 40 of the double shoot attachment 30, and the rear conduit 38 may deliver seeds to a side delivery section 42 of the double shoot attachment 30. In some embodiments, the double shoot attachment 30 may have dual-band outlets in the side delivery section 42 of the double shoot attachment. In such embodiments, the hoe opener assembly 19 may deposit fertilizer on either side of the seeds via the central section 40 and an outlet of the side delivery section 42.

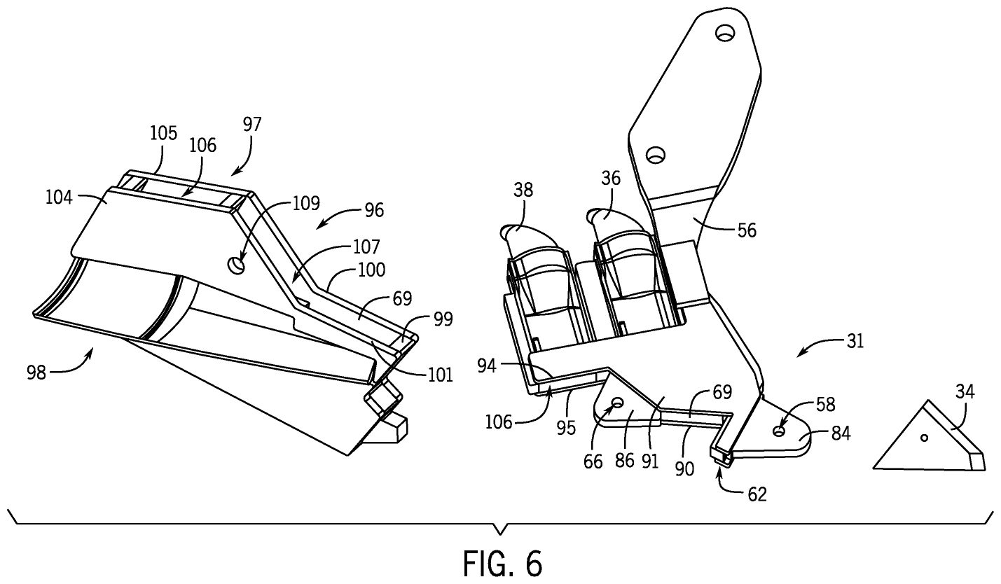

Although the hoe opener assembly 19 is configured for double shoot operation in the illustrated embodiment, in some embodiments, the hoe opener assembly 19 may be configured for single shoot operation. In such embodiments, the hoe opener assembly 19 may include a single shoot attachment instead of the double shoot attachment illustrated in FIG. 2. During single shoot operation of the hoe opener assembly 19, the front conduit 36 may deliver fertilizer to a central section of the single shoot attachment, and the rear conduit 38 may deliver seeds to the central section of the single shoot attachment, such that seeds, fertilizer, or a mixture of the seeds and the fertilizer is deposited in the trench. Additional details with regard to the single shoot attachment are discussed herein with reference to FIG. 6.

Referring back to FIG. 2, the row unit 18 also includes a depth control adjustment assembly 44, with a frame support 20, mounting brackets 22, a first member 24, a second member 26, and a biasing device, such as a cylinder 28 (e.g., hydraulic and/or pneumatic piston-cylinder assembly). The cylinder 28 may be hydraulically coupled to a power supply that provides a flow of pressurized hydraulic fluid which displaces a piston rod 29 extending from the cylinder 28. The frame support 20 and frame brackets 22 are configured to interface with the tool frame, thereby securing the row unit 18 to the tool frame. For instance, multiple row units 18 may be mounted in parallel along the tool frame 16 to form multiple rows 23 of the seeding implement. In the present configuration, the first member 24, the second member 26, and the frame support 20 form elements of a parallel linkage, also known as a four bar linkage. Components of the row unit 18, such as the frame support 20, mounting brackets 22, first member 24, and second member 26, may be made of any suitable material, such as steel.

The cylinder 28 is attached to a shank 27 via a pin 46 at the end of the piston rod. The hoe opener assembly 19 is coupled to the shank 30 and configured to engage the soil of the field. The contact force between the nose 34 and the soil establishes a moment about a shank pivot joint 33. This moment is resisted by force applied to the shank 27 by the cylinder 28. Furthermore, the linkage is configured to facilitate vertical movement of the seeding implement, while substantially maintaining the nose 34 at a target penetration depth within the soil. As illustrated, the linkage is coupled to a packer support structure, such as the illustrated packer support plate 48.

A packer arm 50, which pivotally supports a packer wheel 52, is pivotally coupled to the packer support plate 48. The packer wheel 52 rotates along the soil surface to pack the soil on top of deposited seeds and/or fertilizer in the trench and to limit the penetration depth of the nose 34. As illustrated, a pin 54 disposed through openings within the packer arm 50 and the packer support plate 48 enables rotation of the packer arm 50 with respect to the packer support plate 48. However, in a working mode, rotation of the packer arm 50 relative to the packer support plate 48 is blocked by the depth adjustment assembly 44. The depth adjustment assembly 44 includes a fastener disposed within a slot in the packer support plate 48 and a corresponding slot in the packer arm 50. While in a locked position, the fastener blocks rotation of the packer arm 50 with respect to the packer support plate 48. Conversely, while in an unlocked position, the fastener may be translated within the respective slots to adjust the rotation of the packer arm 50 about the pin 54. Such an adjustment varies the vertical position of the nose 34 relative to the packer wheel 52, thereby altering the penetration depth of the nose 34. Once a desired penetration depth has been established, the fastener may be locked into position, thereby blocking rotation of the packer arm 50 and enabling the hoe opener assembly 19 to enter the working mode. As previously discussed, the packer wheel 52 rotates across a surface of the soil to limit the penetration depth of the nose 34. Consequently, the difference in vertical position between the packer wheel 52 and the nose 34 establishes the penetration depth of the nose 34 within the soil of the field. The packer wheel 52 may at least partially close the trench over the agricultural products disposed in the trench by the hoe opener assembly 19.

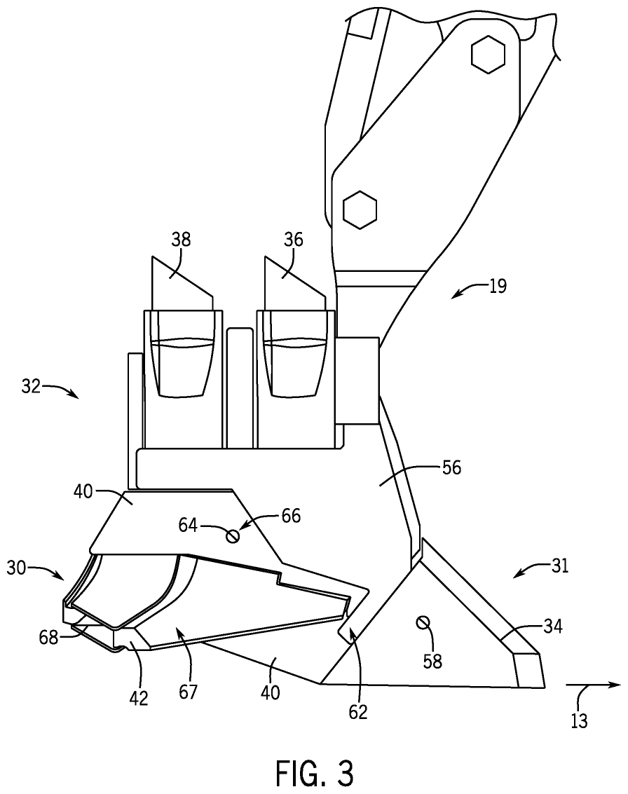

FIG. 3 is a side view of the hoe opener assembly 19 configured for double shoot operation. The hoe opener assembly 19 has a replaceable nose 34 at a front side 31 of the hoe opener assembly 19 and a double shoot attachment 30 at a rear side 32 of the hoe opener assembly 19. The nose 34 is removeably coupled to the base structure 56 of the hoe opener assembly 19 via any suitable fastener at attachment point 58. In some embodiments, the nose 34 may be formed from carbide or another suitable material. Additionally, the double shoot attachment 30 may be removeably coupled to the base structure 56 of the hoe opener assembly 19 via a bolt 64 or any other suitable fastener at attachment point 66. In some embodiments, the nose 34, the double shoot attachment 30, or both may be integrally formed on the base structure 56. An alignment interface 62 of the base structure 56 may facilitate proper alignment of the double shoot attachment 30 with the base structure 56 of the hoe opener assembly 19. For example, the alignment interface 62 of the base structure 56 may engage a corresponding alignment interface of the double shoot attachment 30.

As described above, the hoe opener assembly 19 may engage the field with the nose 34 (e.g., a knife or a blade) of the hoe opener assembly 19 and form a trench in the field as the row unit moves in the direction of travel 13 through the field. The hoe opener assembly 19 may deposit fertilizer into the trench via the front conduit 36 and seeds into the trench via the rear conduit 38. For example, the hoe opener assembly 19 may receive the fertilizer from a first agricultural product delivery tube via the front conduit 36. After passing through the front conduit 36, the fertilizer may flow through the central section 40 of the double shoot attachment 30 into the bottom of the trench. The hoe opener assembly 19 may also receive the seeds from a second agricultural product delivery tube via the rear conduit 38. After passing through the rear conduit 38, the seeds may flow through the side delivery section 42 into the trench via a side delivery outlet 68.

The side delivery section 42 also has a soil spreader 67 (e.g., a lateral knife) that may deflect soil laterally to establish a lateral offset between the deposited fertilizer and the deposited seeds. In the illustrated embodiment, for example, as the hoe opener assembly 19 moves in the direction of travel 13 and forms the trench in the field, soil contacting the soil spreader 67 may be deflected laterally by an upper surface of the soil spreader 67, thereby establishing an indentation in the trench, which receives the seeds via the delivery outlet 68. In some embodiments, the upper surface of the soil spreader 67 may slope generally upwardly toward the central section 40 of the double shoot attachment 30. The soil spreader 67 may be formed from a carbide or another suitable material.

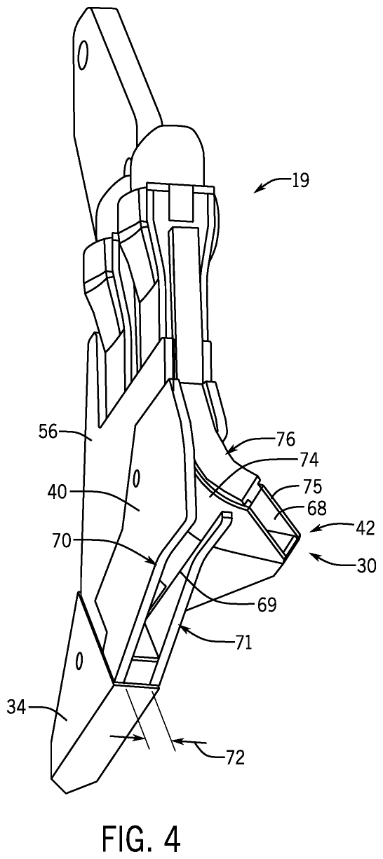

As described above, the fertilizer may flow through the central section 40 of the double shoot attachment 30 into the bottom of the trench formed by the nose 34 of the hoe opener assembly 19. FIG. 4 is a back, perspective view of the hoe opener assembly 19 configured for double shoot operation. The central section 40 of the double shoot attachment 30 has a first wall 70 and a second wall 71 that directs the fertilizer into the trench. The first wall 70 and the second wall 71 form a first passage 69 fluidically coupled to the front conduit 36 and extending through the central section 40. A width 72 of the first passage 69 may define the lateral distribution of the fertilizer to the trench. In some embodiments, the first wall 70 and the second wall 71 are substantially parallel to each other. Additionally, the seeds may flow through the side delivery section 42 of the double shoot attachment 30 into the trench via the side delivery outlet 68. The side delivery section 42 of the double shoot attachment 30 has a first wall 74 and a second wall 75 that form a second passage 76 fluidically coupled to the rear conduit 38 and extending through the side delivery section 42. The first wall 74 and the second wall 75 of the second passage 76 curve in a lateral direction outwardly from the central section 40. As such, the first passage 69 and the second passage 76 may facilitate separate deposition of the fertilizer and the seeds, respectively.

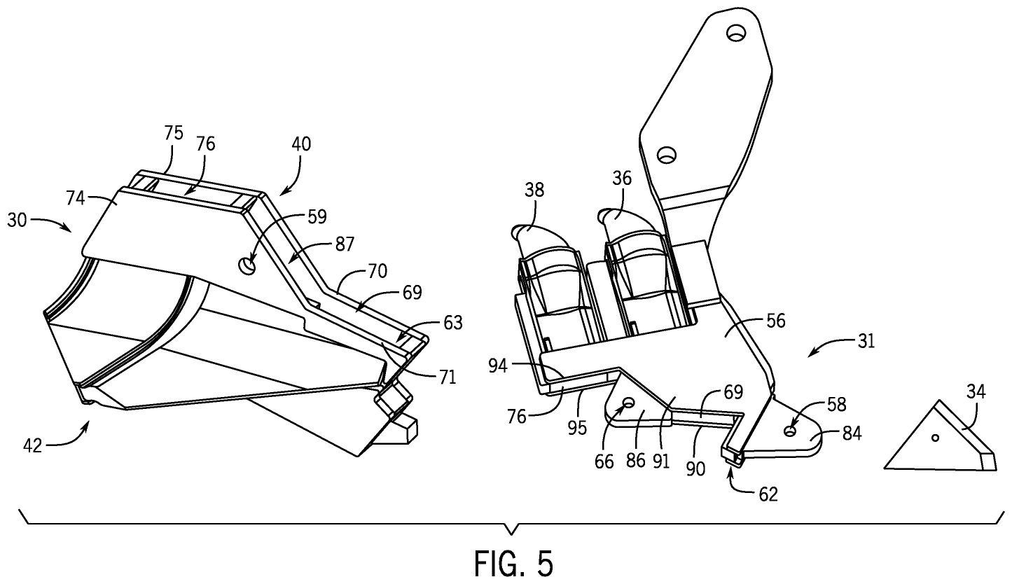

As mentioned above, the base structure 56 of the hoe opener assembly 19 may be coupled to the replaceable nose 34 and the double shoot attachment 30 to facilitate separate delivery of the seeds and the fertilizer to the trench. FIG. 5 is an exploded view of the base structure 56 of the hoe opener assembly 19 and the double shoot attachment 30. In the illustrated embodiment, the base structure 56 has a front mount 84 that is configured to couple to the replaceable nose 34 at the front side 31 of the hoe opener assembly 19. For example, the nose 34 may be removeably coupled to the front mount 84 of the base structure 56 via any suitable fastener at attachment point 58 while the front mount 84 is disposed within a receiving portion of the nose 34. Additionally, the base structure 56 has a back mount 86 that is configured to couple the double shoot attachment 30 to the base structure 56 of the hoe opener assembly 19. For example, a bolt or another suitable fastener may be utilized to couple the central section 40 at attachment point 59 to the back mount 86 at attachment point 66, while the back mount 86 is disposed within a receiving portion 87 of the central section 40.

An alignment interface 62 of the base structure 56 may facilitate proper alignment of the double shoot attachment 30 with the base structure 56 of the hoe opener assembly 19. In the illustrated embodiment, the alignment interface 62 is configured to engage a corresponding alignment interface 63 of the double shoot attachment 30. Thus, when the back mount 86 of the base structure 56 is coupled to the double shoot attachment 30, the first wall 70 and the second wall 71 of the central section 40 align with a first wall 90 and a second wall 91 of the base structure 56. The interface between the first wall 70 of the central section 40 and the first wall 90 of the base structure 56 and the interface between the second wall 71 of the central section 40 and the second wall 91 of the base structure 56 forms the first passage 69, which is fluidically coupled to the front conduit 36. As such, during operation of the hoe opener assembly 19, fertilizer may flow from the front conduit 36 to the trench in the soil via the first passage 69. Additionally, the first wall 74 and the second wall 75 of the side delivery section 42 align with a third wall 94 and a fourth wall 95 of the base structure 56. The interface between the first wall 74 of the side delivery section 42 and the third wall 94 of the base structure and the interface between the second wall 74 of the side delivery section 42 and the fourth wall 95 of the base structure forms the second passage 76, which is fluidically coupled to the rear conduit 38. As such, during operation of the hoe opener assembly 19, seeds may flow from the rear conduit 38 to the trench in the soil via the second passage 76.

In some embodiments, the base structure 56 of the hoe opener assembly 19 may be coupled to the replaceable nose 34 and a single shoot attachment to facilitate delivery of seeds, fertilizer, or a mixture of the seeds and the fertilizer to the trench. FIG. 6 is an exploded view of the base structure 56 of the hoe opener assembly 19 and an embodiment of a single shoot attachment 96. As described above, the base structure 56 has a front mount 84 that is configured to couple to the replaceable nose 34 at the front side 31 of the hoe opener assembly 19. For example, the nose 34 may be removeably coupled to the front mount 84 of the base structure 56 via any suitable fastener at attachment point 58. Additionally, the base structure 56 has a back mount 86 that is configured to couple the single shoot attachment 96 to the base structure 56 of the hoe opener assembly 19. For example, a bolt or another suitable fastener may be utilized to couple the central section 97 of the single shoot attachment 96 at attachment point 109 to the back mount 86 at attachment point 66, while the back mount 86 is disposed within a receiving portion 107 of the central section 97.

An alignment interface 62 of the base structure 56 may facilitate proper alignment of the single shoot attachment 96 with the base structure 56 of the hoe opener assembly 19. In the illustrated embodiment, the alignment interface 62 is configured to engage a corresponding alignment interface 99 of the single shoot attachment 96. Thus, when the back mount 86 of the base structure 56 is coupled to the single shoot attachment 96, the first wall 100 and the second wall 101 of the central section 97 align with the first wall 90 and the second wall 91 of the base structure 52. The interface between the first wall 100 of the central section 97 and the first wall 90 of the base structure 56 and the interface between the second wall 101 of the central section 97 and the second wall 91 of the base structure 56 forms the first passage 69, which is fluidically coupled to the front conduit 36. Additionally, the first wall 104 and the second wall 105 of the side delivery section 98 align with the third wall 94 and the fourth wall 95 of the base structure 52. The interface between the first wall 104 of the side delivery section 98 and the third wall 94 of the base structure and the interface between the second wall 105 of the side delivery section 98 and the fourth wall 95 of the base structure forms a second passage 106, which is fluidically coupled to the rear conduit 38. The second passage 106 may direct the seeds to the first passage 69 within the single shoot attachment 96 to facilitate mixing of the seeds with the fertilizer passing through the first passage 69. As such, during operation of the hoe opener assembly 19, seeds, fertilizer, or a mixture of the seeds and the fertilizer may flow through the first passage 69 to the trench.

Technical effects of the improved hoe opener assembly described above include decreasing the time and labor associated with switching between a single shoot configuration of the hoe opener assembly and a double shoot configuration of the hoe opener assembly, as well as reducing costs compared to the repair or the replacement of the hoe opener assembly. For example, the hoe opener assembly may have a base structure that may be utilized with both a single shoot attachment and a double shoot attachment of the hoe opener assembly. In the single shoot configuration, a rear mount of the base structure may be coupled to the single shoot attachment that facilitates delivery of seeds, fertilizer, or a mixture of seeds and fertilizer to a trench created by a nose of the hoe opener assembly. In the double shoot configuration, the rear mount of the base structure may be coupled to the double shoot attachment that facilitates separate delivery of the seeds and the fertilizer to the trench. An operator may easily and efficiently exchange the single shoot attachment with the double shoot attachment, or vice versa, based on the desired seed and fertilizer deposition technique. Additionally, certain components of the hoe opener assembly may be replaceable to reduce costs compared to the repair or the replacement of the hoe opener assembly. For example, embodiments of the present disclosure provide a replaceable nose of the hoe opener assembly in addition to the interchangeable single shoot and double shoot attachments described above. That is, the nose of the hoe opener assembly, the single shoot attachment, and the double shoot attachment are removeably coupled to the base structure of the hoe opener assembly, such that the components may easily and efficiently be replaced with replacement components by an operator after the components have experienced a certain amount of wear.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any elements containing elements designated in any other manner, it is intended that such elements are not to be interpreted under 35 U.S.C. 112(f).

1. A row unit of an agricultural seeding implement, comprising:
a hoe opener assembly configured to engage soil to form a trench in the soil and to deposit one or more agricultural products in the trench, wherein the hoe opener assembly comprises:
a base structure having a mount configured to be removeably coupled to a single shoot attachment or a double shoot attachment, wherein the single shoot attachment is configured to deposit seeds, fertilizer, or a mixture of the seeds and the fertilizer into the trench and the double shoot attachment is configured to separately deposit the fertilizer and the seeds into the trench;
a nose removeably coupled to the base structure, wherein the nose is configured to form the trench in the soil;
a first conduit configured to deliver the fertilizer to the single shoot attachment or the double shoot attachment; and
a second conduit configured to deliver the seeds to the single shoot attachment or the double shoot attachment.

2. The agricultural seeding implement of claim 1, wherein the mount is removeably coupled to the single shoot attachment.

3. The agricultural seeding implement of claim 2, wherein the single shoot attachment comprises a first passage configured to be fluidically coupled to the first conduit and a second passage configured to be fluidically coupled to the second conduit, and the second passage is configured to deliver the seeds to the first passage to facilitate mixing of the seeds and the fertilizer before deposition into the trench.

4. The agricultural seeding implement of claim 1, wherein the mount is removeably coupled to the double shoot attachment, and wherein the double shoot attachment comprises a first passage fluidically coupled to the first conduit and a second passage fluidically coupled to the second conduit.

5. The agricultural seeding implement of claim 4, wherein the second passage comprises a curved section configured to deposit the seeds laterally outward from the fertilizer.

6. The agricultural seeding implement of claim 5, wherein the double shoot attachment comprises a soil spreader.

7. The agricultural seeding implement of claim 1, wherein the base structure comprises an alignment interface configured to engage a corresponding alignment interface at the single shoot attachment or the double shoot attachment.

8. A hoe opener assembly, comprising:
a base structure having a first mount and a second mount;
a nose removeably coupled to the first mount, wherein the nose is configured to form a trench in soil;
a double shoot attachment removeably coupled to the second mount, wherein the double shoot attachment comprises a central section having a first passage configured to deposit fertilizer at a first region of the trench and a curved section having a second passage configured to deposit seeds at a second region of the trench, wherein the curved section curves outward from the central section;
a first conduit fluidically coupled to the first passage and configured to deliver the fertilizer to the first passage; and
a second conduit fluidically coupled to the second passage and configured to deliver the seeds to the second passage.

9. The hoe opener assembly of claim 8, wherein a single shoot attachment is configured to be coupled to the second mount.

10. The hoe opener assembly of claim 9, wherein the single shoot attachment comprises a first passage configured to be fluidically coupled to the first conduit and a second passage configured to be fluidically coupled to the second conduit.

11. The hoe opener assembly of claim 10, wherein the second passage of the single shoot attachment is configured to direct the seeds to the first passage of the single shoot attachment to facilitate mixing of the seeds with the fertilizer passing through the first passage.

12. The hoe opener assembly of claim 8, wherein the base structure comprises a shank configured to be mounted to a frame of an agricultural implement.

13. The hoe opener assembly of claim 8, wherein the base structure comprises an alignment interface configured to engage a corresponding alignment interface at the single shoot attachment or the double shoot attachment.

14. The hoe opener assembly of claim 8, wherein the double shoot attachment comprises a soil spreader.

15. A row unit of an agricultural seeding implement, comprising:
a hoe opener assembly configured to engage soil to form a trench in the soil and to deposit one or more agricultural products in the trench, wherein the hoe opener assembly comprises:
a base structure having a mount;
a nose removeably coupled to the base structure, wherein the nose is configured to form the trench in the soil;
a double shoot attachment removeably coupled to the mount, wherein the double shoot attachment is configured to separately deposit the fertilizer and the seeds into the trench;
a first conduit configured to deliver the fertilizer to the double shoot attachment; and
a second conduit configured to deliver the seeds to the double shoot attachment.

16. The agricultural seeding system of claim 15, wherein the double shoot attachment comprises a first passage fluidically coupled to the first conduit and a second passage fluidically coupled to the second conduit.

17. The agricultural seeding system of claim 16, wherein the second passage comprises a curved section configured to deposit the seeds laterally outward from the fertilizer.

18. The agricultural seeding system of claim 17, wherein the double shoot attachment comprises a soil spreader.

19. The agricultural seeding system of claim 15, wherein a single shoot attachment is configured to be coupled to the mount, the single shoot attachment configured to deposit seeds, fertilizer, or a mixture of the seeds and the fertilizer into the trench.

20. The agricultural seeding system of claim 19, wherein the single shoot attachment comprises a first passage configured to be fluidically coupled to the first conduit and a second passage configured to be fluidically coupled to the second conduit.
